(19) United States
(12) Patent Application Publication
(10) Pub. No.: US 2009/0169962 A1
(43) Pub. Date: Jul. 2, 2009

(54) Integrated flow field plate and diffusion electrode in a fuel cell

(75) Inventors: I Ming Hsing, Tseung Kwan O (HK); Haifeng Zhang, Clear Water Bay (HK)

Correspondence Address: THE NATH LAW GROUP, 112 South West Street, Alexandria, VA, 22314, US

(73) Assignee: THE HONG KONG UNIVERSITY OF SCIENCE AND TECHNOLOGY, Hong Kong (CN)

(21) Appl. No.: 11/976,937

(22) Filed: Oct. 30, 2007

Related U.S. Application Data
(60) Provisional application No. 60/857,912, filed on Nov. 13, 2006.

(51) Int. Cl. H01M 4/00; H01M 4/60; H01M 4/96

(52) U.S. Cl. 429/34

(57) ABSTRACT

A fuel cell has at least one electrode having channels for delivering reactants, products, or both. The electrode is an anode or cathode of the fuel cell, or both. The electrode can serve as both a liquid diffusion layer and a flow field plate, thus replacing the traditional elements of carbon paper, cloth diffusion layer, and anode current collector. In some aspects, the fuel cell uses methanol, and the electrode is formed from flexible graphite. The electrode can have a structure sufficient to permit methanol diffusion while preventing methanol crossover. The electrode can also improve volumetric power density and eliminate contact resistance typically present between a conventional flow field plate and conventional diffusion electrode layer.

### CROSS-REFERENCE TO RELATED APPLICATIONS

This application claims the benefit of U.S. Provisional Patent Application No. 60/857,912, filed Nov. 13, 2006, the contents of which are hereby incorporated by reference in their entirety.

### BACKGROUND OF THE INVENTION

1. Field of the Invention

The present invention relates generally to fuel cells, and more particularly to flow fields and electrode structures of fuel cells and to the control of diffusion rates of reactants in a liquid-feed fuel cell system.

2. Related Art

Fuel cells are promising power sources for their high energy efficiency. A solid polymer fuel cell is a specific type of fuel cell, and can employ a membrane electrode assembly (MEA). As shown in FIG. 1, an MEA comprises a solid electrolyte membrane 1 sandwiched between a cathode 3 and an anode 5, electrically connected by wire 7. Optional catalysts layers 2 can be placed between the anode or cathode and the solid electrolyte membrane. Flow field plates 4 are disposed on either side of the MEA. These flow field plates, together with clamping plates 8 and seals 6, ensure the good delivery of anode fuel and cathode oxidant to the reactant zone and efficient removal of byproducts therefrom. In operation, chemical reactions at the anode produce electrons and protons. The protons travel through the membrane 1 and arrive at the cathode. Meanwhile, the electrons travel along the wire 7, creating a useful electrical current, before rejoining the protons at the cathode in further chemical reactions.

A direct liquid-feed fuel cell is a type of solid polymer fuel cell which operates with at least one kind of liquid reactant as a fuel. One typical direct liquid-feed fuel cell uses methanol as a fuel, and is referred to as a direct methanol fuel cell (DMFC). Besides methanol, other organic fuels such as ethanol or dimethyl ether can also be used as fuel in a direct liquid fuel cell.

DMFCs, like ordinary batteries, provide DC electricity from two electrochemical reactions. These reactions occur at electrodes (or poles) to which reactants are continuously fed. The negative electrode (anode) is maintained by supplying methanol, whereas the positive electrode (cathode) is maintained by the supply of air. When providing current, methanol is electrochemically oxidized at the anode diffusion electrode to produce electrons, which travel through the external circuit to the cathode diffusion electrode where they are consumed together with oxygen in a reduction reaction. The circuit is maintained within the cell by the conduction of protons in the electrolyte. One molecule of methanol (CH₃OH) and one molecule of water (H₂O) together store six atoms of hydrogen. When fed as a mixture into a DMFC, they react to generate one molecule of CO₂, 6 protons (H+), and 6 electrons to generate a flow of electric current. The protons and electrons generated by the methanol and water react with oxygen to generate water.

So far, two main obstacles prevent DMFCs from widespread commercial applications. One obstacle is a low catalyst activity for methanol electro-oxidation. The other obstacle is the crossover of methanol through the polymer electrolyte membrane to the cathode. It has been realized that methanol crossover not only lowers fuel utilization efficiency but also reduces the output voltage of the methanol/oxygen electrochemical system. Typically, to reduce this methanol crossover, the concentration of methanol feed to the anode is highly diluted (e.g. at or below 2 molar (M)). Unavoidably, the “dilution” requirement lowers the reaction rate of methanol oxidation, and thus sacrifices the energy density of a compact DMFC system. This is particularly deleterious where a physically small fuel cell is desired, such as in portable electronics applications.

Some prior art patents and publications have attempted to address the crossover issue through the modification of the membrane, either through the modification of an industry-standard Nafion® based membrane, or through the development of a new membrane material. In either case, the goal is to reduce the amount of methanol that crosses through the membrane. While some of these methods have reported data which demonstrates some reduction of methanol crossover, other electrochemical and mechanical properties (e.g. proton conductivity, mechanical strength and cost) of the new membranes are unavoidably compromised.

Several related studies that utilize methanol diffusion characteristics to improve fuel cell performance were recently reported.

Oedegaard and Hentschel (A. Oedegaard, C. Hentschel, J. Power Sources 158 (2006) 177-187) presented a portable DMFC stack operating in a passive mode with an interesting methanol feeding concept, wherein a continuous methanol supply to compensate the methanol consumption was achieved in the feed loop by having a permeable tube in a concentrated methanol storage tank to facilitate methanol diffusion. However, the use of a specialized permeable tube can be costly and difficult to implement, and in any case the methanol consumption problem is in many ways not sufficiently addressed by this concept.

Abdelkareem and Nakagawa (M. Ali Abdelkareem, N. Nakagawa, J. power Sources 162 (2006) 114-123) introduced a porous carbon plate between the anode current collector and methanol fuel tank. The CO₂ gas formed between the anode and porous plate could reduce the mass transport flux of methanol and subsequently retard the methanol crossover. One advantage of this interesting approach is the achievability of running DMFC at high methanol operations. However, the formation and retention of a stable CO₂ layer can become a very difficult task, especially during long-term operation.

In another recent paper published by Kim et al. (W. J. Kim, H. G. Choi, Y. K. Lee, J. D. Nam, S. M. Cho, C. H. Chung, J. Power Sources, 157 (2006) 193-195) a similar concept of restricting the mass transport of methanol was studied. Instead of using CO₂, the approach utilized hydrogel based fuel cartridges as a way to control methanol diffusion flux through the membrane, which consequently improved the DMFC performance at high methanol concentrations, e.g. 8 M. However, the necessity of a hydrogel based fuel cartridge can lead to increased costs and assembly time for the fuel cell.

More generally, even the use of a separate diffusion electrode and liquid flow field plate can lead to increased manufacturing costs and time, and contact resistance therebetween can lead to decreased fuel cell efficiency.

### SUMMARY OF THE INVENTION

The present disclosure describes a new electrode module featuring an integrative structure that serves as both a diffusion electrode and a liquid flow field plate. This structure allows a fuel cell system to be fed by a high concentration liquid fuel (e.g. methanol) while reducing the liquid fuel (e.g. methanol) which crosses over to the cathode side. Manufacturing and assembly of the fuel cell can be simplified and costs can be reduced.

The present disclosure includes a fuel cell comprising at least one electrode having channels for delivering reactants, products, or both. The electrode serves as an anode or cathode of the fuel cell.

In some aspects, a proton conductive material of the fuel cell is adjacent to the electrode. In some alternative aspects, a proton conductive material of the fuel cell is adjacent to a catalyst layer, which in turn is adjacent to the electrode. This catalyst may optionally be decaled on the electrode. Further, this catalyst may optionally be directly coated on the surface of a diffusion layer of the electrode.

In some aspects, the electrode comprises a diffusion layer, and no other diffusion layer is adjacent to the electrode in the fuel cell. Optionally, the diffusion layer may include carbon, graphite, metal foam, polymer, conductive polymer, or combinations of these.

In some aspects, the channels form a flow field pattern, such as a parallel, serpentine, interdigitated, pin-type, or spiral pattern.

In some aspects, the fuel cell includes methanol, which is delivered by the channels. Optionally, the methanol can have a concentration from about 25 M to about 0.1 M. This is only one range of concentrations the methanol can take, however, and many others may be used in the present disclosure, including but not limited to: a concentration from about 25 M to about 10 M; a concentration from about 10 M to about 0.1 M; a concentration from about 25 M to about 0.05 M; a concentration from about 15 M to about 8 M; a concentration from about 15 M to about 10 M; a concentration form about 18 M to about 12 M; and a concentration from about 20 M to about 5 M.

In some aspects, the fuel cell includes methanol, and the electrode comprises flexible graphite. Optionally, the electrode can have a structure sufficient to permit methanol diffusion while preventing methanol crossover across the membrane. Optionally, the methanol concentration can be greater than about 8 M. This is only one concentration the methanol can take, and others may be used in the present disclosure, including but not limited to: greater than about 20 M; greater than about 18 M; greater than about 15 M; greater than about 12 M; greater than about 10 M; a concentration from about 25 M to about 10 M; a concentration from about 10 M to about 0.1 M; a concentration from about 25 M to about 0.05 M; a concentration from about 15 M to about 8 M; a concentration from about 15 M to about 10 M; a concentration form about 18 M to about 12 M; and a concentration from about 20 M to about 5 M.

In some aspects, the fuel cell includes methanol, but has no carbon paper diffusion layer.

In some aspects, the electrode includes a porous gas diffusion layer or porous liquid diffusion layer. Optionally, the average diameter of pores may be from 0.1 microns to 100 microns. This is only one range of average diameters the pores may have, however, and others may be used in the present disclosure, including but not limited to: from 0.05 microns to 100 microns; from 0.1 microns to 500 microns; from 0.05 microns to 500 microns; from 0.1 microns to 50 microns; and from 10 micron to 100 microns; from 10 microns to 50 microns.

In some aspects, the electrode includes a porous gas diffusion layer treated with PTFE solution to make its surface hydrophobic. Optionally, the porous gas diffusion layer may comprise a layer of PTFE whose weight is less than about 50% of the weight of the porous gas diffusion layer. This is only one range of weights, however, and others may be used, including but not limited to: from about 10% to about 75% of the weight of the porous gas diffusion layer; from about 1% to about 50% of the weight of the porous gas diffusion layer; from about 1% to about 75% of the weight of the porous gas diffusion layer; from about 10% to about 35% of the weight of the porous gas diffusion layer; from about 20% to about 50% of the weight of the porous gas diffusion layer; from about 20% to about 35% of the weight of the porous gas diffusion layer

In some aspects, the electrode comprises a metal foam diffusion layer. Optionally, the metal foam may include nickel, stainless steel, and combinations of these. However, other metals may be used. Optionally, there may be no other diffusion layer adjacent to the electrode.

In some aspects, the electrode comprises a conductive polymer diffusion layer.

In some aspects, the electrode comprises an electroplated polymer diffusion layer.

In some aspects, the anode and the cathode of the fuel cell each comprise channels for delivering reactants, products, or both.

The present disclosure also includes an electrode for a fuel cell, comprising a porous diffusion layer. The porous diffusion layer includes, but is not limited to, one or more materials such as carbon, graphite, metal foam, a polymer, a conductive polymer, or an electroplated polymer. The porous diffusion layer has channels for delivering reactants, products, or both. Optionally, the average diameter of the pores in the porous diffusion layer ranges is from 0.1 to 100 microns. This is only one range of average diameters the pores may have, however, and others may be used in the present disclosure, including but not limited to: from 0.05 microns to 100 microns; from 0.1 microns to 500 microns; from 0.05 microns to 500 microns; from 0.1 microns to 50 microns; and from 10 micron to 100 microns; from 10 microns to 50 microns.

The present disclosure also includes a fuel cell including at least one electrode having a structure sufficient to permit liquid diffusion while preventing liquid crossover. The electrode comprises carbon or graphite. Optionally, the electrode has a thickness, density, and porosity sufficient to permit liquid diffusion while preventing liquid crossover. Optionally, the liquid is methanol. Optionally, the fuel cell is capable of operating at a methanol feed concentration of greater than about 8 M. This is only one concentration the methanol can take, and others may be used in the present disclosure, including but not limited to: greater than about 20 M; greater than about 18 M; greater than about 15 M; greater than about 12 M; greater than about 10 M; a concentration from about 25 M to about 10 M; a concentration from about 10 M to about 0.1 M; a concentration from about 25 M to about 0.05 M; a concentration from about 15 M to about 8 M; a concentration from about 15 M to about 10 M; a concentration form about 18 M to about 12 M; and a concentration from about 20 M to about 5 M.

### BRIEF DESCRIPTION OF THE DRAWINGS

The features, nature, and advantages of the presently disclosed methods and apparatuses will become more apparent from the detailed description set forth below when taken in conjunction with the drawings in which like reference characters identify corresponding items throughout and wherein:

FIG. 1 shows a typical solid polymer fuel cell.

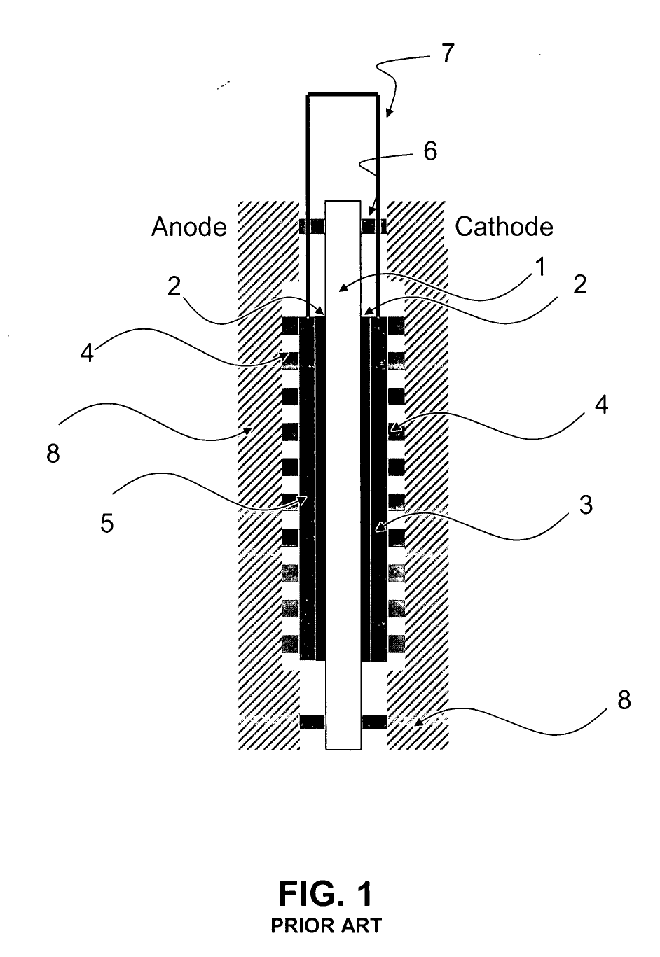

FIG. 2 shows one aspect of a fuel cell according to the present disclosure.

FIG. 3 shows a detail of the fuel cell of FIG. 2.

FIG. 4 charts the Open Circuit Voltage (OCV) performance of fuel cells with and without the structure of FIG. 2, operating at methanol concentrations (from 0.25 M to 18 M).

FIG. 5 charts the limiting methanol permeation current density at the cathodes of fuel cells with and without the structure of FIG. 2, at different methanol concentrations.

FIG. 6 charts the performance of fuel cells with and without the structure of FIG. 2, operating at high methanol concentrations.

FIG. 7 charts the stability of current produced from a fuel cell according to FIG. 2.

FIG. 8 shows an aspect of a membrane electrode assembly according to the present disclosure.

FIG. 9 charts a performance curve for a fuel cell utilizing the membrane electrode assembly of FIG. 8.

### DETAILED DESCRIPTION

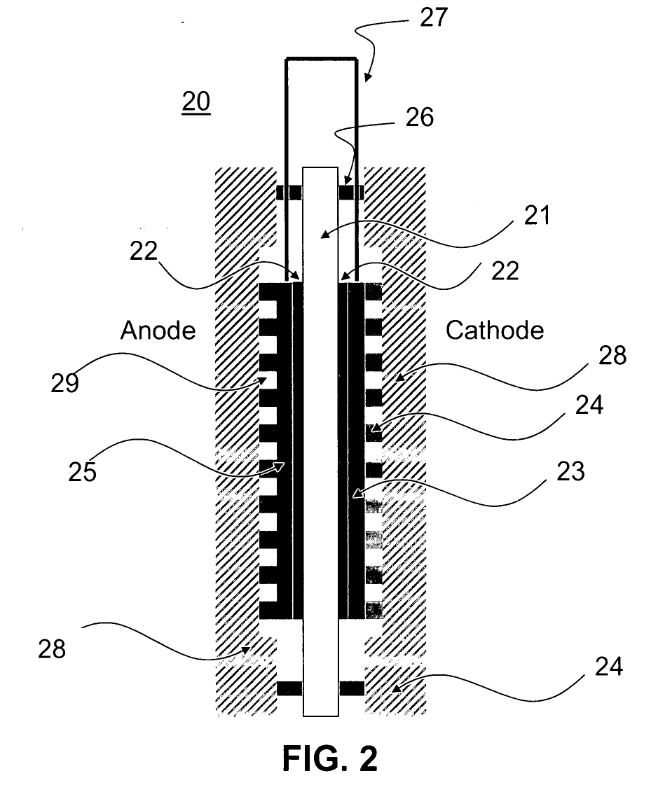

Making reference to FIG. 2, a fuel cell 20 includes a proton conductive material 21. The present disclosure is applicable to many types of fuel cells, so accordingly, the proton conductive material may comprise any number of known or novel materials, including but not limited to any solid polymer electrolyte or ion exchange membrane. When the fuel cell is a direct methanol fuel cell, the proton conductive material may optionally comprise the sulfonated tetrafluorethylene copolymer known as Nafion® and manufactured by DuPont Fuel Cells, Fayetteville, N.C. However, the present disclosure may also be used with such fuel cells as alkaline fuel cells generally, proton exchange membrane fuel cells, phosphoric acid fuel cells, molten carbonate fuel cells, solid oxide fuel cells, metal hydride fuel cells, electro-galvanic fuel cells, direct formic acid fuel cells, microbial fuel cells, reversible fuel cells, direct borohydride fuel cells, alkaline fuel cells, reformed methanol fuel cells, direct ethanol fuel cells, formic acid fuel cells, protonic ceramic fuel cells, direct carbon fuel cell, and solid oxide fuel cells. This is a non-limiting list, and other fuel cell types may also be used.

As shown in FIG. 2, the proton conductive material 21 is contacted on either side by a catalyst layer 22. This is optional, however, and the choice of whether or not to use a catalyst layer, or of which catalyst material to use, is largely a function of fuel cell type and the type of diffusion electrode or proton conductive material used. When the fuel cell is a direct methanol fuel cell, the catalyst layer may comprise platinum, ruthenium, gold, or combinations thereof. Optionally, the catalyst may be directly coated on the surface of a diffusion layer of an electrode, such as the conventional diffusion electrode 23 shown, or may be decaled thereon.

On the cathode side, the catalyst layer 22 is adjacent to a conventional diffusion electrode 23. (In some embodiments, however, no catalyst layer 22 is needed, and the proton conductive material 1 is directly adjacent to the diffusion electrode 23, whether anode or cathode). The cathode diffusion electrode 23 allows for the recombination of protons (which have traveled through the proton conductive material 21) with electrons (which have traveled from the anode along wire 7 to the cathode electrode). When the fuel cell is a direct methanol fuel cell, the protons and electrons combine at the diffusion electrode 23 to form water.

The diffusion electrode is in turn adjacent to a conventional flow field plate 24. The flow field plate comprises channels or grooves that guide reactants and products to and from the cathode's diffusion electrode 23. When the fuel cell is a direct methanol fuel cell, water (a product of the fuel cell's reaction) is guided away from the cathode's diffusion electrode along the grooves of the flow field plate. When the fuel cell is a direct methanol fuel cell, contact resistance may form between the flow field plate 24 and the electrode 23. Again, clamping plates 28 and seals 26 are used to assure good flow.

Many shapes of flow fields may be formed in the flow field plate, including but not limited to parallel, serpentine, interdigitated, pin-type, or spiral patterns.

On the anode side, an electrode 25 according to the present disclosure is shown adjacent to a catalyst layer. This novel electrode 25 has channels 29 within it for delivering reactants, products, or both, much as a conventional flow field plate 24 might. In this way, the electrode may be referred to as an “integrative” electrode, since the roles of the conventional flow field plate and diffusion layer have been combined. In the case of such an “integrative” electrode 25, no additional flow field plate is needed. The flow field plate and anode diffusion layer are combined to form a structure whose channels guide reactants and products. When the fuel cell is a direct methanol fuel cell, methanol and water (reactants of the fuel cell's reaction) are guided along the anode diffusion electrode 25 through its own channels 29, and not those of any auxiliary flow field plate 24, as is shown for the cathode. The electrode 25 continues to act as a current collector or distributor, even while performing the additional duties of flow control. Volumetric power density can be improved, while contact resistance (such as would normally occur between the flow field plate and a conventional electrode) can be removed.

Many shapes of flow fields may be formed in the electrode, including but not limited to parallel, serpentine, interdigitated, pin-type, or spiral patterns.

In a typical fuel cell, the electrode may include a diffusion layer, or more often a separate diffusion layers is used with a conductive electrode layer. For example, in a conventional direct methanol fuel cell, a carbon paper diffusion layer may be used with a fabric backing and a conductive current collector.

In the present example, in contradistinction, electrode 25 may include one or more diffusion layers, where no other diffusion layer is adjacent to the electrode in the fuel cell, and the diffusion layer of the electrode 25 includes one or more materials such as carbon, graphite, metal foam, polymer, conductive polymer, or combinations of these. A metal foam, if used, may include nickel, stainless steel, or combinations of these. A polymer, if used, may be electroplated.

When the electrode includes a porous gas diffusion layer or a porous liquid diffusion layer, many pore sizes may be used. The pore size may be selected based on the material forming the electrode, and may also or alternatively be selected to control the flow of diffusion of reactants through the electrode and toward the membrane 21 (and optional catalyst 22). The average diameter of pores in the diffusion layer may be from 0.1 microns to 100 microns; from 0.05 microns to 100 microns; from 0.1 microns to 500 microns; from 0.05 microns to 500 microns; from 0.1 microns to 50 microns; and from 10 micron to 100 microns; from 10 microns to 50 microns. These are merely examples, and other diameters may be used.

The porous gas diffusion layer may optionally be treated with Polytetrafluoroethylene (PTFE) solution (known under the DuPont brand name Teflon®) to make its surface hydrophobic. This is advantageous where water is a reactant of byproduct. The layer of PTFE may have a weight less than about 50% of the weight of the porous gas diffusion layer; from about 10% to about 75% of the weight of the porous gas diffusion layer; from about 1% to about 50% of the weight of the porous gas diffusion layer; from about 1% to about 75% of the weight of the porous gas diffusion layer; from about 10% to about 35% of the weight of the porous gas diffusion layer; from about 20% to about 50% of the weight of the porous gas diffusion layer; from about 20% to about 35% of the weight of the porous gas diffusion layer. These are merely examples, and other weight rations of PTFE may be used.

By selecting the proper material for the electrode 25, the proper structure of channels 29, and the proper porosity of the electrode's diffusion layer, higher concentrations of reactants may be used, without the conventional risk of significant crossover of the reactant from the anode to the cathode. As a non-limiting example, where the channels 29 deliver methanol, the methanol can have a concentration greater than about 8 M. This is only one example, however, and other concentrations may be used, including but not limited to: from about 25 M to about 0.1 M; from about 25 M to about 10 M; from about 10 M to about 0.1 M; from about 25 M to about 0.05 M; from about 15 M to about 8 M; from about 15 M to about 10 M; from about 18 M to about 12 M; from about 20 M to about 5 M; greater than about 20 M; greater than about 18 M; greater than about 15 M; greater than about 12 M; and greater than about 10 M.

Although conventional carbon plates may be provided with channels according to the present disclosure, in the following example, outstanding performance was seen with a DMFC whose integrated electrode was made from a flexible graphite plate. The pore structure of layered graphite materials provides excellent methanol-blocking characteristics, and flexible graphite in general has the desirable properties of high temperature resistance, good chemical resistance, high electric conductivity, good porosity, and low cost.

### Example 1

### Direct Methanol Fuel Cell (DMFC) with Anodic Integrative Structure

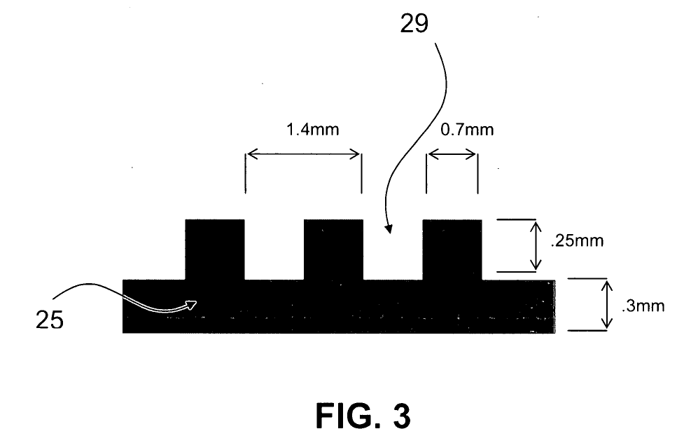

Again making reference to FIG. 2, in one aspect of the present disclosure, a fuel cell includes an anode 25 made from a flexible graphite plate. In this example, a conventional cathode is used. The flexible graphite plate is mechanically-molded (or otherwise structured) to form a flow field pattern for product and reactant transport. For example, parallel flow field patterns may be mechanically formed in the graphite plate for methanol transport. Methanol solution flows through the channels 29 and diffuses through the electrode 25 to the interface between the catalyst 22 and the membrane 21. The diffusion flux of aqueous methanol to the interface can be effectively adjusted to a reasonable level by controlling the structure of electrode 25, such as its porosity. Typical spacing and sizes of parallel flow field patterns for the present disclosure are shown in FIG. 3, where inter-channel spacing is about 1.4 mm, channel boundary width is about 0.7 mm, channel depth is about 0.25 mm, and electrode thickness is about 0.3 mm. However, these dimensions are non-limiting, and are shown as only one aspect of the present disclosure. Many other dimensions and flow field designs may be used according to the present disclosure.

As a specific example, a catalyst coated membrane, integrated anode electrode, and membrane electrode assembly were prepared in the following manner.

Nafion® (DuPont, USA) 115 membranes were purified by three sequential boiling steps in the solutions of (1) 3 wt % H₂O₂, (2) de-ionized water and (3) 0.5 M H₂SO₄. Each step took two hours. Finally, the membrane was rinsed in boiling deionized water for two hours. Catalysts at anode and cathode were unsupported Pt/Ru black (4 mg cm⁻² metal loading) and Pt black (2.5 mg cm⁻² loading), respectively. The catalyst ink was made by ultrasonically mixing 5 wt % Nafion, water-wetted catalysts and appropriate amount of ethanol. The weight ratio between catalyst and Nafion was 85:15 for the anode and 90:10 for the cathode, respectively. The well-dispersed inks were sprayed onto the Teflon blanks. Then the catalyzed layer was transferred onto the Nafion 115 membrane by thin film decal method. (A catalyst-coated-membrane (CCM) can be obtained by treating the membrane at 140° C. for 90 seconds to remove the water and then hot-pressed at 140° C. and 10 ATM for 120 seconds).

Flexible graphite sheet materials were obtained from Qing-Dao Advanced Seals Inc., China. One side of the graphite was mechanically molded to form a parallel flow field pattern for methanol transport; while the other side was placed in direct contact with the anode catalyst layer. The bulk region of the layered graphite sheets served as the methanol diffusion layer. A gas diffusion layer at the cathode was made on Toray® paper (Toray Industrials Inc., Japan) with thickness of 0.4 mm by a homogeneous brushing of a mixture containing a desired amount of carbon particles (Vulcan XC-X72), polytetrafluoroethylene (PTFE) and ethanol. The total content of PTFE at the diffusion layer was 20 wt % and the loading of carbon was 1 mg cm⁻². The diffusion layer coated paper was then heated at 340° C. for 50 min at N₂ atmosphere. Finally, the catalyst-coated membrane was sandwiched between a flexible-graphite anode and cathode diffusion layer at a hot-pressing condition of 135° C. and 70 atm for 90 s to form a MEA unit of an active geometric area of 4.5 cm². A stainless steel mold of the flexible-graphite anode was used as a support during the hot-pressing process to prevent the graphite channels from being broken.

A conventional MEA containing a traditional anode structure, but with the same loading of PTFE and carbon as cathode diffusion layer, was made for comparison in cell performance. As in FIG. 2, unlike the cathode electrode with an additional gas diffusion layer, the integrated anode plate provides the function of current collector, flow field plate, and liquid (i.e. methanol) diffusion layer. The adoption of flexible-graphite based anode greatly simplifies the design of the fuel cell system, and the interesting properties of the flexible graphite (e.g. porosity and conductivity) provide a unique opportunity to operate DMFC at high methanol concentrations. Mechanical strength of the flexible graphite anode can be improved by the support of a carbon-based plate.

The flux of methanol crossover through the membrane could be obtained by measuring the transport-controlled limiting current occurring at the membrane/cathode catalyst interface. A similar process was reported by Shao et al. (Z. G. Shao, X. Wang, I.-M. Hsing, J. Membr. Sci. 210 (2002) 147-153). Methanol solutions were fed to the anode at a volumetric flow rate of 0.8 mL min⁻¹ and a humidified N₂ stream at a flow rate of 100 mL min⁻¹ was fed to the cathode. Using the Autolab PSTAT20 potentiostat (Eco Chemie, the Netherlands) with a dynamic potential range from 0.1 to 1.2V at the scanning rate of 3 mV s⁻¹, the limiting current of crossover methanol was recorded. The anode where H₂ evolution took place served as dynamic hydrogen reference electrode (DHE) and counter electrode.

The cell performance of DMFCs was measured by a FCT-2000 fuel cell testing station (ElectroChem, USA). A single fuel cell unit was operated at an active mode where a peristaltic pump was used to drive methanol aqueous solution at the flow rate of 0.8 mL min⁻¹ to the anode flow field with 0 atm back pressure and oxygen humidified at 65° C. was fed to the cathode at 0.35 L min⁻¹ with 1 atm back pressure. The operating pressure of anode and cathode was maintained at zero and 1 atm, respectively.

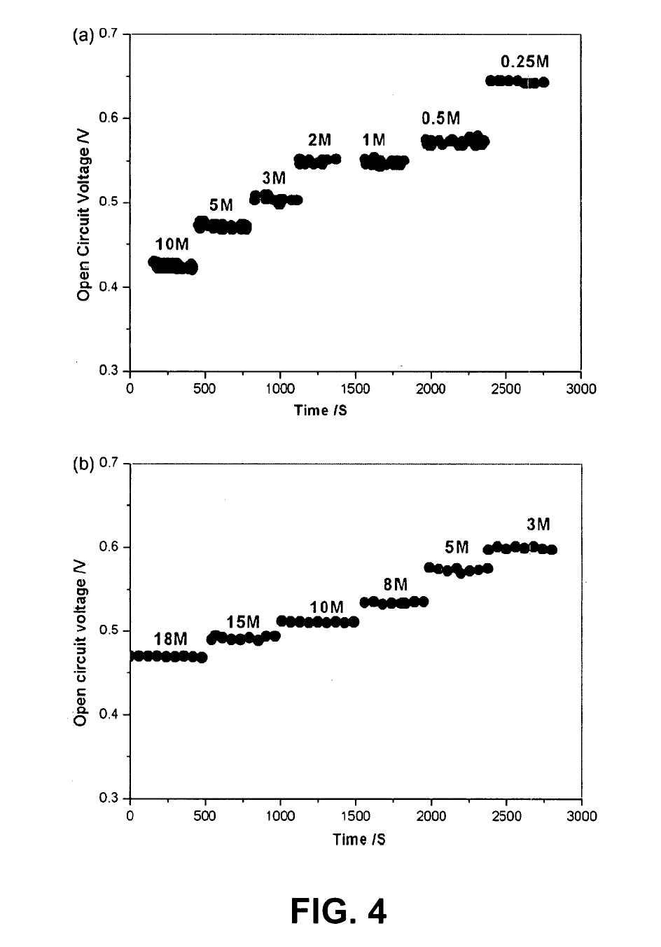

FIG. 4 shows the evolution of Open Circuit Voltage in a DMFC (a) with and (b) without an integrated anode structure, at a methanol concentration of 0.25 M-18 M. The OCV reading can take several minutes to get stabilized upon the change of methanol concentration. It can be seen that the OCV value drops along with the increase of methanol concentration for both types of DMFCs. However, the OCV of the DMFC with an integrated anode was much higher than that of a conventional DMFC with a traditional anode structure (i.e. carbon paper diffusion layer and carbon-graphite flow field) at the same methanol concentration. For example, the OCV of the new structure was 0.51 V at 10 M compared to an OCV of 0.425 V by a conventional counterpart.

In measuring membrane methanol diffusion coefficient, Barragan and Heinzel have established an equation to delineate the relationship between OCV and methanol concentration (see V. M. Barragan, A. Heinzel, J. Power Sources 104 (2002) 66-72). Using a similar derivation and incorporating the additional mass transfer barrier of methanol due to the integrated anode structure, OCV can be expressed as:

$$\begin{matrix}OCV = {E}_{cell} - χ \cdot {J}_{MeOH} \\ = {E}_{cell} - χ ( \frac{{C}_{o}}{{δ}_{a} / {D}_{Me , a} + ( {δ}_{m} / {D}_{Me , m} ) + ( 1 / k ) + A ⋆ Δ P} )\end{matrix}$$

where E_{cell} is the cell potential, χ an empirical constant, J_{MeOH} the methanol crossover flux, D_{Me,a} and D_{Me,m} the diffusion coefficients of methanol in the anode and electrolyte, respectively, δa and δm the thickness of the anode and membrane, respectively, Cₒ is the feed methanol concentration, k the mass transfer coefficient for the cathode side, A the empirical constant and ΔP is the pressure difference between cathode and anode.

As it can be seen in FIG. 4, the integrated anode plays an important role in limiting the methanol crossover flux and it offers a much higher OCV at the same feed methanol concentration compared to the conventional DMFC. Moreover, it opens up the possibility of operating DMFC at a high methanol feed concentration (e.g. 10-18 M). The reason of the OCV increase for the “new” DMFC could be easily explained by the above equation. Although a high methanol feed concentration (Co) would adversely affect the OCV, nevertheless, the increase in mass transfer resistance (i.e. a higher value of δa/D_{Me,a}) provided by the flexible-graphite based integrated anode structure effectively compensates the high feed concentration effect and maintains the high OCV value. The value of δa/D_{Me,a} can be engineered by controlling the thickness, density and porosity of the flexible graphite materials.

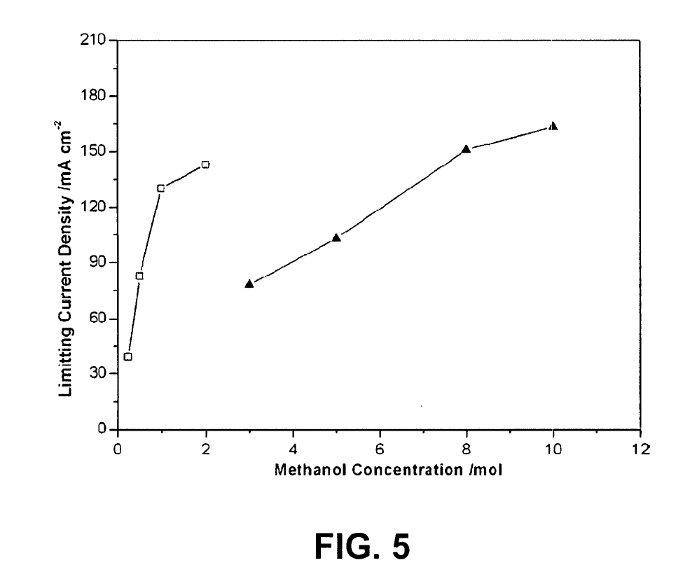

FIG. 5 shows the limiting methanol permeation current density at the cathode at different methanol concentrations. Limiting permeation current density of methanol at the cathode with and without an integrated anode structure at different methanol concentrations are shown; open square points correspond to a conventional DMFC, while triangular points correspond to an integrated anode based DMFC. Cell temperature was controlled at 70° C. with the supplies of 0.8 mL min⁻¹ methanol solution and 0.1 L min⁻¹ N₂ humidified at 65° C. onto the anode and cathode, respectively. The scanning rate was 3 mV s⁻¹.

The methanol permeation current is an indication of methanol flux across the membrane. Consistent with the OCV result shown above, the integrated anode based DMFC can sustain a much higher methanol feed concentration (8 M versus 2 M) at a methanol crossover flux (i.e. methanol permeation current density) comparable to the conventional DMFC.

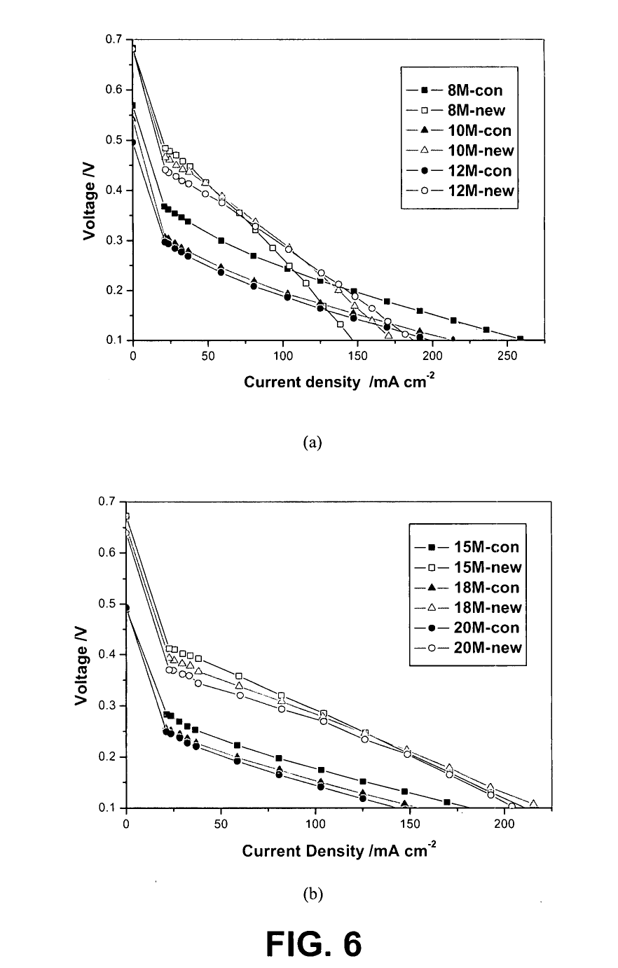

FIG. 6 shows performance curves of DMFCs with and without an integrated anode structure according to the present disclosure, operating at high methanol concentrations, (8 M-20 M). Chart (a) shows polarization curves for methanol feed at 8 M-12 M and chart (b) shows polarization curves for methanol feed at 15 M-20 M. Closed points correspond to a conventional DMFC, while open points correspond to a DMFC with an integrated anode according to the present disclosure. Cell temperature was controlled at 70° C. with the supplies of 0.8 mL min⁻¹ methanol solution and 0.35 L min⁻¹ O₂ humidified at 65° C. onto the anode and cathode, respectively.

The integrated anode one clearly outperforms the cell polarization data of conventional DMFC at low current densities. This is believed to occur because methanol crossover has been effectively reduced for DMFC with the integrated anode. However, note that, at high current density conditions, a mass transfer limitation is seen for the integrated-anode based DMFC (e.g. at 8 M operation) and the performance of DMFC with an integrated anode according to the present disclosure drops faster than that of a conventional DMFC. Nevertheless, as it can be seen from chart (b) of FIG. 6, because of the copious supply of methanol (15 M or above), the integrated anode DMFC shows a better polarization characteristics even at high current densities.

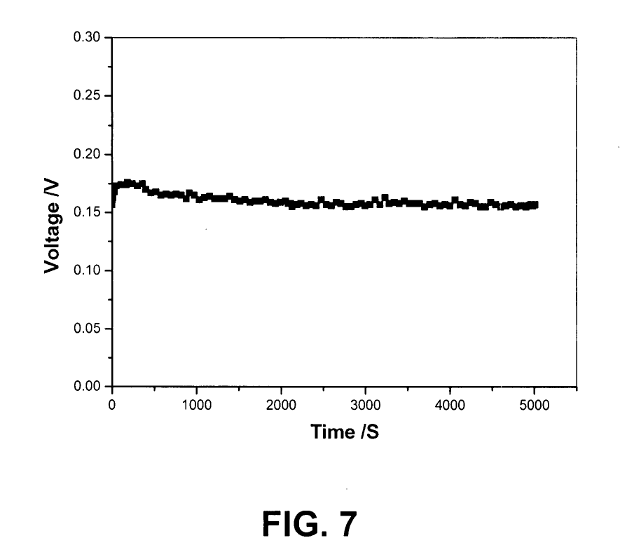

FIG. 7 shows stable cell performance of a fuel cell according to the present disclosure at a current density of 150 mA cm⁻² and a methanol concentration of 12 M; cell temperature was controlled at 70° C. with 0.8 mL min⁻¹ methanol solution flow and 0.35 L min⁻¹ O₂ humidified at 65° C. onto the anode and cathode, respectively. Stable cell performance was observed for more than one and a half hours.

According to another aspect of the present disclosure, both the anode and the cathode of a fuel cell may be formed from flexible graphite and provided with channels for flow.

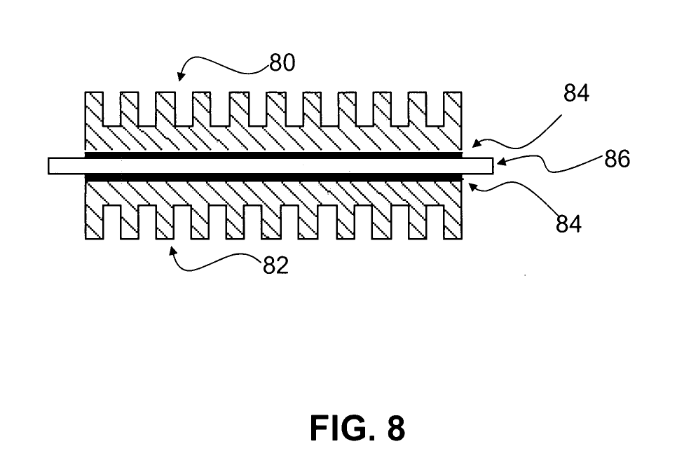

FIG. 8 shows an electrolyte membrane 86 sandwiched between catalyst layers 84, which contact an anode 80 on one side, and a cathode 82 on the other. Both the anode and the cathode comprise channels, which are comprised by flow field patterns for reactant or product transport.

When the fuel cell is a direct methanol fuel cell, the cathode will be in contact with water. Thus, the cathode may optionally be immersed in 5% PTFE solution and loaded 20 wt % PTFE, as was done here. The cathode was then annealed for 50 min at 340° C. However, the anode need not be treated with PTFE solution, and was not done here. The catalyst-coated membrane was sandwiched between both anode and cathode structured at a hot-pressing condition of 135° C. and 70 atm for 90 sec to form a unit.

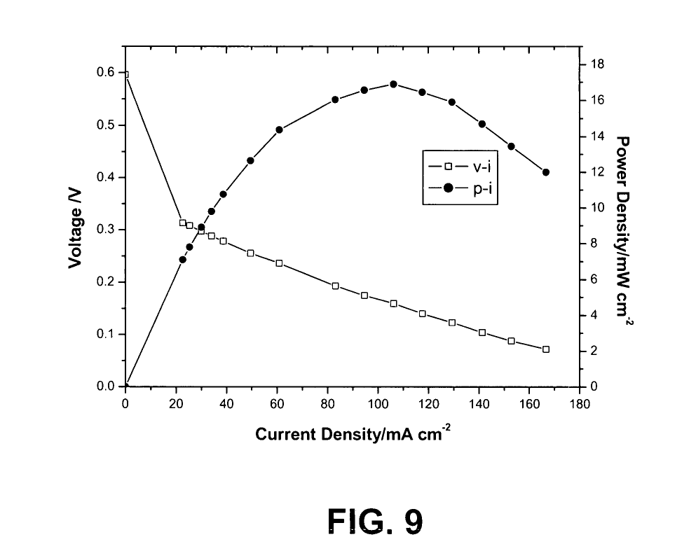

FIG. 9 charts performance curves of a DMFC as described with reference to FIG. 8. The maximum output power is approximately 16 mW cm⁻².

According to another aspect of the present disclosure, an electrode for a fuel cell comprises a porous diffusion layer. The porous diffusion layer includes, but is not limited to, one or more materials such as carbon, graphite, metal foam, a polymer, a conductive polymer, or an electroplated polymer. The porous diffusion layer has channels for delivering reactants, products, or both. Optionally, the average diameter of the pores in the porous diffusion layer ranges is from 0.1 to 100 microns. This is only one range of average diameters the pores may have, however, and others may be used in the present disclosure, including but not limited to: from 0.05 microns to 100 microns; from 0.1 microns to 500 microns; from 0.05 microns to 500 microns; from 0.1 microns to 50 microns; and from 10 micron to 100 microns; from 10 microns to 50 microns. The electrode may be used in a fuel cell to replace an existing electrode, diffusion layer, and flow plate.

According to another aspect of the present disclosure, a fuel cell includes at least one electrode having a structure sufficient to permit liquid diffusion while preventing liquid crossover. The electrode need not necessarily have channels at its surface. The electrode comprises carbon or graphite. Optionally, the electrode has a thickness, density, and porosity sufficient to permit liquid diffusion while preventing liquid crossover. It is envisioned that the use of a flexible graphite plate alone can provide advantages, even without the use of channels. Optionally, the liquid is methanol. Optionally, the fuel cell is capable of operating at a methanol feed concentration of greater than about 8 M. This is only one concentration the methanol can take, and others may be used in the present disclosure, including but not limited to: greater than about 25 M; greater than about 20 M; greater than about 18 M; greater than about 15 M; greater than about 12 M; greater than about 10 M; a concentration from about 25 M to about 10 M; a concentration from about 10 M to about 0.1 M; a concentration from about 25 M to about 0.05 M; a concentration from about 15 M to about 8 M; a concentration from about 15 M to about 10 M; a concentration form about 18 M to about 12 M; and a concentration from about 20 M to about 5 M.

The previous description of some aspects is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Thus, the present invention is not intended to be limited to the aspects shown herein but is to be accorded the widest scope consistent with the principles and novel features disclosed herein.

What is claimed is:

1) A fuel cell, the fuel cell comprising:
an anode, and
a cathode, wherein
at least one of said anode and said cathode comprises at least one electrode, the electrode comprising one or more channels for delivering reactants, products, or both.

2) The fuel cell of claim 1, wherein the fuel cell comprises a proton conductive material adjacent the electrode.

3) The fuel cell of claim 1, wherein the fuel cell comprises a proton conductive material and a catalyst layer adjacent the proton conductive material, and wherein the electrode is adjacent the catalyst layer.

4) The fuel cell of claim 3, wherein the catalyst layer is decaled on the electrode or is directly coated on the surface of a diffusion layer of the electrode.

5) The fuel cell of claim 1, wherein the electrode comprises a diffusion layer, and wherein no other diffusion layer is adjacent the electrode in the fuel cell.

6) The fuel cell of claim 5, wherein the diffusion layer comprises a material selected from the group consisting of: carbon, graphite, metal foam, polymer, conductive polymer, and combinations thereof.

7) The fuel cell of claim 1, wherein the channels form a flow field pattern, and the flow field pattern is selected from the group consisting of: parallel, serpentine, interdigitated, pin-type, and spiral.

8) The fuel cell of claim 1, wherein the fuel cell comprises methanol delivered by the channels.

9) The fuel cell of claim 8, wherein the methanol has a concentration from about 25 M to about 0.1 M.

10) The fuel cell of claim 8, wherein the electrode comprises flexible graphite.

11) The fuel cell of claim 10, wherein the fuel cell comprises a proton conductive material adjacent the electrode or a proton conductive material adjacent a catalyst layer adjacent the electrode, and wherein the electrode has a structure sufficient to permit methanol diffusion while preventing methanol crossover across said proton conductive material.

12) The fuel cell of claim 11, wherein the methanol has a concentration greater than about 8 M.

13) The fuel cell of claim 8, wherein the fuel cell has no carbon paper diffusion layer.

14) The fuel cell of claim 1, wherein the electrode comprises a porous gas diffusion layer or porous liquid diffusion layer.

15) The fuel cell of claim 14 wherein the average diameter of pores is from 0.1 to 100 microns.

16) The fuel cell of claim 1, wherein the electrode comprises a porous gas diffusion layer treated with Polytetrafluoroethylene (PTFE) solution to make its surface hydrophobic, wherein the weight of PTFE is less than about 50% of the weight of the porous gas diffusion layer.

17) The fuel cell of claim 1, wherein the anode and the cathode of the fuel cell each comprise channels for delivering reactants, products, or both.

18) The fuel cell of claim 1, wherein the electrode comprises a porous gas diffusion layer or porous liquid diffusion layer, and wherein the porous gas diffusion layer or the porous liquid diffusion layer comprises a metal foam selected from the group consisting of: nickel, stainless steel, and combinations thereof, and wherein no other diffusion layer is adjacent the electrode.

19) The fuel cell of claim 1, wherein the electrode comprises a porous gas diffusion layer or porous liquid diffusion layer, and wherein the porous gas diffusion layer or the porous liquid diffusion layer comprises a conductive polymer, and wherein no other diffusion layer is adjacent the electrode.

20) The fuel cell of claim 1, wherein the electrode comprises a porous gas diffusion layer or porous liquid diffusion layer, and wherein the porous gas diffusion layer or the porous liquid diffusion layer comprises an electroplated polymer diffusion layer, and wherein no other diffusion layer is adjacent the electrode.

21) An electrode for a fuel cell, the electrode comprising:
a porous diffusion layer comprising a material selected from the group consisting of carbon, graphite, metal foam, conductive polymer, and combinations thereof; and
channels formed within the porous diffusion layer for delivering reactants, products, or both,
wherein the average diameter of all pores in the porous diffusion layer is from 0.1 to 100 microns.

22) A fuel cell, the fuel cell comprising:
at least one electrode, the electrode comprising carbon or graphite, the electrode having a structure sufficient to permit liquid diffusion while preventing liquid crossover.

23) The fuel cell of claim 22, the electrode having a thickness, density, and porosity sufficient to permit liquid diffusion while preventing liquid crossover.

24) The fuel cell of claim 22, wherein the liquid is methanol.

25) The fuel cell of claim 24, the fuel cell capable of operating at a methanol feed concentration of greater than about 8 M.
